(19) United States
(12) Patent Application Publication
(10) Pub. No.: US 2026/0296209 A1
(43) Pub. Date: Oct. 1, 2026

(54) METHOD FOR CONTROLLING TORQUE OUTPUT OF AN ELECTRIC MOTOR OF AN ELECTRIC VEHICLE

(71) Applicant: BOMBARDIER RECREATIONAL PRODUCTS INC., Valcourt (CA)

(72) Inventor: Benoit SIMARD, Bromont (CA)

(21) Appl. No.: 19/475,831

(22) PCT Filed: Apr. 25, 2024
(86) PCT No.: PCT/IB2024/054062

§ 371 Date: Oct. 16, 2025

Related U.S. Application Data
(60) Provisional application No. 63/498,879, filed on Apr. 28, 2023.

(51) Int. Cl. B60L 3/10; B60L 15/20

(52) U.S. Cl. CPC B60L 3/10; B60L 15/20; B60L 2200/12; B60L 2240/423

(57) ABSTRACT

A method for controlling torque output of an electric motor of an electric vehicle. The electric vehicle having at least one ground engaging member. The method includes: receiving an accelerator position; determining a desired torque from the accelerator position; determining a varying torque based at least in part on the desired torque; and controlling the electric motor to apply the varying torque. An electric vehicle having a vehicle control unit and an inverter having memory storing computer executable instructions for executing the method is also disclosed.

### CROSS-REFERENCE

The present application claims priority to U.S. Provisional Patent Application No. 63/498,879, filed Apr. 28, 2023, the entirety of which is incorporated herein by reference.

### FIELD OF TECHNOLOGY

The present technology relates to methods for controlling torque output of an electric motor of an electric vehicle and to electric vehicles having an electric motor controlled by such methods.

### BACKGROUND

It has been found that in certain motorcycles equipped with an internal combustion engine having irregular torque output can be beneficial, especially at high speed, such as in professional racing conditions on a closed circuit. For example, in some V-type engines the angle between consecutive ignition events, and therefore between torque peaks, cause the driven wheel to have peaks in traction that are then released before the driven wheel slips, thus providing improved performance and driver feedback.

Many manufacturers are now replacing the internal combustion engines with electric motors. Although electric motors can produce high torque, for a constant torque demand by the driver, there is no torque variation over one rotation of the output shaft of the electric motor. As such, the above effect found in motorcycles having an internal combustion engine is not found in motorcycles having an electric motor. An electric motorcycle can be controlled even with the driven wheel slipping, however reducing the amount of slip could provide improved performance and driver feedback.

There is therefore a desire for an electric motorcycle in which the issue of wheel slip at high speed is addressed.

### SUMMARY

It is an object of the present technology to ameliorate at least some of the inconveniences present in the prior art.

According to one aspect of the present technology, there is provided a method for controlling torque output of an electric motor of an electric vehicle. The electric vehicle having at least one ground engaging member. The method comprises: receiving an accelerator position; determining a desired torque from the accelerator position; determining a varying torque based at least in part on the desired torque; and controlling the electric motor to apply the varying torque.

In some embodiments, the method further comprises: selecting one of a standard mode and a torque varying mode. In response to the standard mode being selected, the method comprises: controlling the electric motor to apply the desired torque. In response to the torque varying mode being selected: the varying torque is determined; and the electric motor is controlled to apply the varying torque.

In some embodiments, the method further comprises receiving a varying torque input request from a manual input device. The electric motor is controlled to apply the varying torque in response to the varying torque input request being received.

In some embodiments, the method further comprises determining an onset of slip of at least one of the ground engaging members driven by the electric motor. The electric motor is controlled to apply the varying torque in response to the onset of slip being determined.

In some embodiments, the varying torque is determined and the electric motor is controlled to apply the varying torque only in response to the desired torque being greater than a predetermined torque.

In some embodiments, determining the varying torque comprises: determining a torque variation; and adding the torque variation to the desired torque.

In some embodiments, determining the torque variation comprises multiplying a torque profile by an amplitude value.

In some embodiments, the amplitude value is based at least in part on the desired torque.

In some embodiments, the torque profile is selected from a plurality of torque profiles.

In some embodiments, the varying torque is synchronous with a speed of rotation of the electric motor.

In some embodiments, the varying torque is asynchronous with a speed of rotation of the electric motor.

According to one aspect of the present technology, there is provided a method for controlling torque output of an electric motor of an electric vehicle. The electric vehicle having at least one ground engaging member. The method comprises: determining an onset of slip of at least one of the ground engaging members driven by the electric motor; and in response to the onset of slip being determined: determining a varying torque; and controlling the electric motor to apply the varying torque.

In some embodiments, the method further comprises: receiving an accelerator position; determining a desired torque from the accelerator position; and selecting one of a standard mode and a torque varying mode. In response to the standard mode being selected, the method comprises controlling the electric motor to apply the desired torque. In response to the torque varying mode being selected: the varying torque is determined, the varying torque being based at least in part on the desired torque; and the electric motor is controlled to apply the varying torque.

In some embodiments, the varying torque is determined and the electric motor is controlled to apply the varying torque only in response to the desired torque being greater than a predetermined torque.

In some embodiments, determining the varying torque comprises: determining a torque variation; and adding the torque variation to the desired torque.

In some embodiments, determining the torque variation comprises multiplying a torque profile by an amplitude value.

In some embodiments, the amplitude value is based at least in part on the desired torque.

In some embodiments, the torque profile is selected from a plurality of torque profiles.

In some embodiments, the varying torque is synchronous with a speed of rotation of the electric motor.

In some embodiments, the varying torque is asynchronous with a speed of rotation of the electric motor.

According to another aspect of the present technology, there is provided an electric vehicle having: a battery pack; an inverter electrically connected to the battery pack; an electric motor electrically connected to the inverter; a vehicle control unit electronically communicating with the inverter; and at least one ground engaging member operatively connected to and driven by the electric motor. The vehicle control unit and the inverter have memory storing computer executable instructions for executing at least one of the above methods.

In some embodiments, the at least one ground engaging member is at least one wheel.

In some embodiments, the at least one wheel is a rear wheel. The electric vehicle is an electric motorcycle further comprising: a handlebar; a front wheel operatively connected to the handlebar; and a straddle seat disposed rearward of the handlebar.

For the purposes of the present application, terms related to spatial orientation such as forward, rearward, front, rear, upper, lower, left, and right, are as they would normally be understood by a driver of the vehicle sitting therein in a normal driving position with the vehicle being upright and steered in a straight-ahead direction.

Embodiments of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects, and advantages of embodiments of the present technology will become apparent from the following description, the accompanying drawings, and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a top, front, left side perspective view of an electric motorcycle according to a non-limiting embodiment of the present technology;

FIG. 2 is a top, rear, right side perspective view of the motorcycle of FIG. 1;

FIG. 3 is a left side elevation view of a portion of a frame, a powerpack, and an electric motor of the motorcycle of FIG. 1;

FIG. 4 is a diagram of some of the electric and electronic components of the motorcycle of FIG. 1;

FIG. 5 is a flowchart of a portion of a method for controlling a torque output of the electric motor of the motorcycle of FIG. 1 that is executed by a vehicle control unit of the motorcycle of FIG. 1;

FIG. 6 is a flowchart of a portion of the method for controlling the torque output of the electric motor of the motorcycle of FIG. 1 that is executed by an inverter of the motorcycle of FIG. 1; and

FIG. 7 illustrates different tables and corresponding graphs of examples of torque profiles used by the method of FIGS. 5 and 6.

It should be noted that, unless otherwise explicitly specified herein, the drawings are not necessarily to scale.

### DETAILED DESCRIPTION

The present technology will be described herein with respect to a two-wheeled electric motorcycle 100. It is contemplated that aspects of the present technology could also be implemented in different electric vehicles, such as, but not limited to, three-wheeled electric vehicles, electric all-terrain vehicles, side-by-side off-road vehicles, and electric karts. It is also contemplated that aspects of the present technology could also be implemented in electric vehicles having at ground engaging member that is not a wheel. For example, it is contemplated that aspects of the present technology could be implemented in electric vehicles in which at least one of the ground engaging members is an endless track.

While the motorcycle 100 illustrated herein is a street style electric motorcycle 100, it is contemplated that motorcycles according to the present technology could vary by a plurality of vehicle characteristics. These vehicle characteristics could include, but are not limited to, a rider posture configuration (also referred to as a rider position), a motorcycle type, tire type, a wheelbase, a steering arrangement, a weight distribution, a squat ratio, a rake angle, a seat height, and a mechanical trail. The rider posture configuration, or rider position, is the relative spacing and position of a rider's hands (when holding the handlebars), the rider's feet (when positioned on the footrests) and the rider's buttocks (when the rider is seated on a seat of the motorcycle). The steering arrangement could also vary and can be described by a variety of parameters, including but not limited to: a length of front suspension travel, a length of rear suspension travel, a front suspension stiffness, a rear suspension stiffness, a front and/or rear wheel size, rake angle, mechanical trail, triple clamp offset, squat ratio, and wheelbase.

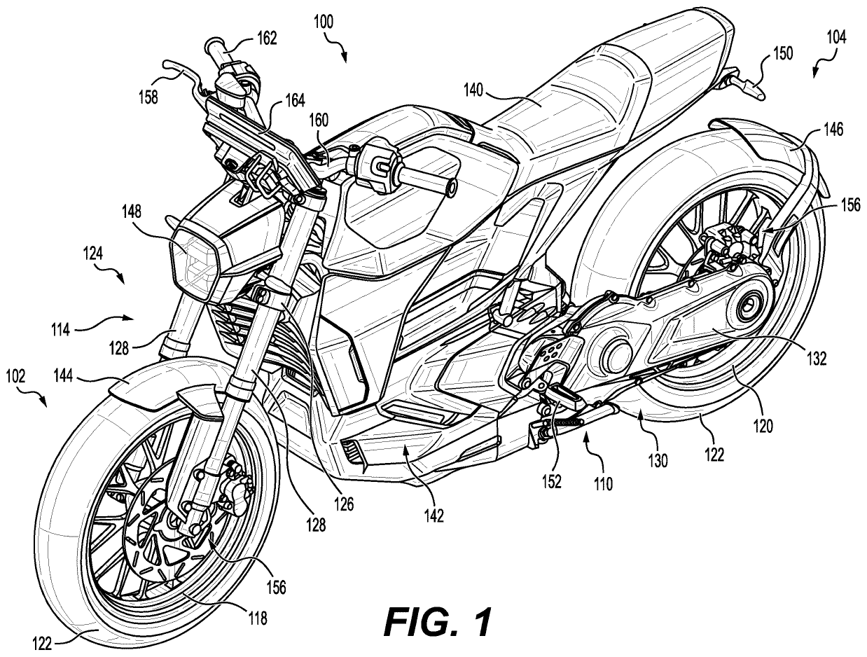

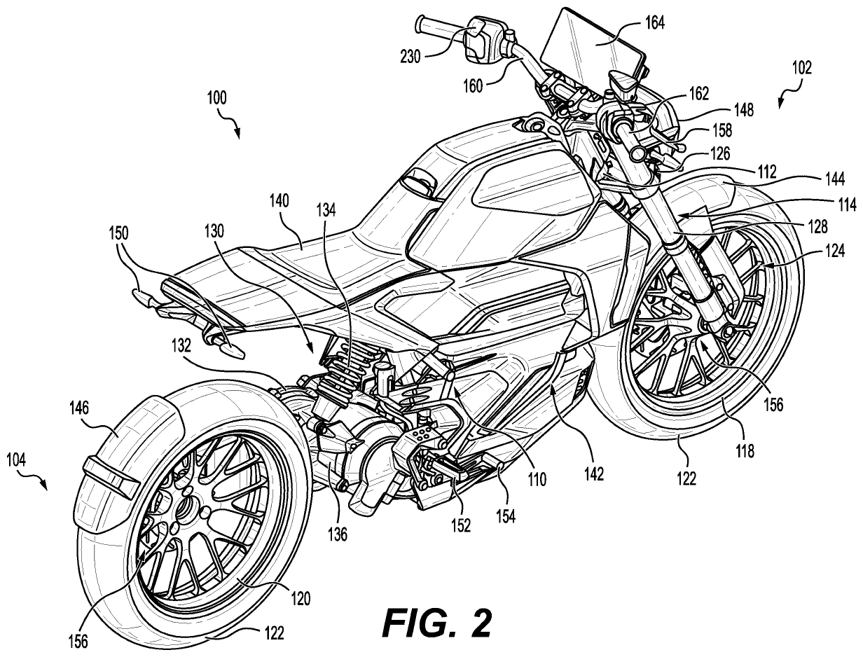

With reference to FIGS. 1 and 2, the electric motorcycle 100, referred to herein as the vehicle 100, has a front end 102 and a rear end 104 defined consistently with the forward travel direction of the vehicle 100.

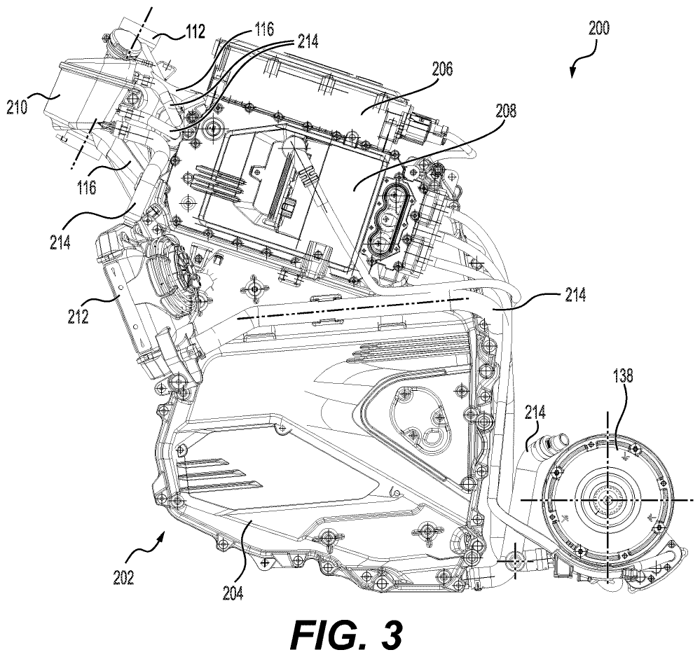

The vehicle 100 has a frame 110. The frame 110 includes a front suspension receiving portion 112, specifically a tube 112 (FIG. 3), sometimes referred to as a “head tube”, for receiving therethrough a front fork assembly 114. Extending rearward from the tube 112, the frame 110 includes forward frame members 116, some of which are shown in FIG. 3. The frame 110 includes several additional frame members.

The vehicle 100 includes a front wheel 118 and a rear wheel 120. The front wheel 118 and the rear wheel 120 each have a tire 122 secured thereto. The front wheel 118 is connected to the frame 110 by a front suspension assembly 124. The front suspension assembly 124 includes the front fork assembly 114 for supporting the front end 102 of the vehicle 100. The front fork assembly 114 includes a triple clamp assembly 126 connected to the tube 112 of the frame 110. The front fork assembly 114 includes a pair of front shocks 128 connected to the triple clamp assembly 126. The front wheel 118 is connected to a bottom portion of the pair of front shocks 128. The rear wheel 120 mounted to the frame 110 by a rear suspension assembly 130. The rear suspension assembly 130 includes a swing arm 132 and a shock absorber 134 (FIG. 2). The swing arm 132 is pivotally mounted at a front thereof to the frame 110. The swing arm 132 includes a swing arm housing 136, in which is disposed an electric motor 138 (FIG. 3) and a drivetrain (not shown). The rear wheel 120 is rotatably mounted to the rear end of the swing arm 132 which extends on a left side of the rear wheel 120. As the swing arm 132 pivots relative to the frame 110, the motor 138 and the rear wheel 120 move with the swing arm 132. In the present embodiment, the electric motor 138 is a three-phase electric motor 138. It is contemplated that different types of motors could be used in other embodiments. In the present embodiment, the drivetrain is a belt and sprocket system that operatively connect the motor 138 to the rear wheel 120. It is contemplated that other types of drivetrains could be used, such as a chain and sprocket system for example. The shock absorber 134 is connected between the swing arm 132 and the frame 110. It is contemplated that the relative arrangement of the shock absorber 134 and the frame 110 could vary in different embodiments.

The vehicle 100 has a straddle seat 140 mounted to the frame 110.

The vehicle 100 further includes a plurality of body panels 142 for forming the body of the vehicle 100. The body panels 142 are connected to and supported by the frame 110. The body panels 142 enclose and protect some internal components of the vehicle 100 such as a powerpack 200 (described further below). The vehicle 100 also includes a front fender 144 extending partially over the front wheel 118. Rearward of the seat 140, the vehicle 100 also has a rear fender 146 extending at partially over the rear wheel 120.

Depending on the embodiment, the body panels 142 and the fenders 144, 146 could be different in shape and number. For example, some embodiments of the vehicle 100 could include a mud flap connected to a rear edge of one of the body panels 142. It is further contemplated that one or both fenders 144, 146 and/or at least one body panel 142 could be omitted in some cases.

The vehicle 100 includes a front headlight 148 attached to the front fork assembly 114 and rear braking and indicator lights 150.

Driver footrests 152 are disposed on either side of the vehicle 100 vertically lower than the straddle seat 140 to support the driver's feet. The driver footrests 152 are connected to the frame 110. A brake pedal 154 is connected to the right driver footrest 152 for braking the vehicle 100. The brake pedal 154 extends upwardly and forwardly from the right driver footrest 152 such that the driver can actuate the brake pedal 154 with a front portion of the right foot while a rear portion of the right foot remains on the right driver footrest 152.

Each of the wheels 118, 120 is provided with a brake assembly 156. Each brake assembly 156 is a disc-type brake assembly 156 mounted onto the spindle of the respective wheel 118 or 120. The brake pedal 154, as well as a hand-operated brake lever 158, are operatively connected to the brake assemblies 156.

The vehicle 100 includes a handlebar 160 connected to the front fork assembly 114 and disposed in front of the seat 140. The handlebar 160 is used by the rider to turn the front wheel 118, via the front fork assembly 114, to steer the vehicle 100. Specifically, the handlebar 160 is connected to a top end of the triple clamp assembly 126. The handlebar 160 and the triple clamp assembly 126 define a steering axis about which the front wheel 118 turns to steer the vehicle 100. A twist-grip accelerator 162 is operatively connected on the right side of the handlebar 160 for controlling vehicle speed. It is contemplated that the twist-grip accelerator 162 could be replaced by an accelerator lever or some other type of accelerator. The brake lever 158 is also connected on a right side of the handlebar 160. A display 164 is connected to the handlebar 160. The display 164 is configured to display various information to a rider of the vehicle 100, including, but not limited to, vehicle speed, charge level of a battery pack 202 of the vehicle 100, and navigation information. In some embodiments, the display 164 forms part of an infotainment system of the vehicle 100.

It is contemplated that the vehicle 100 could include a variety of different features not described herein, including but not limited to: a windscreen, radio and/or navigational systems, and luggage rack systems.

With reference to FIG. 3, power is provided to the motor 138 by the electronic powerpack 200. The powerpack 200 includes the battery pack 202. The battery pack 202 includes a battery housing 204 and a plurality of battery cells (not shown) housed in the battery housing 204. Depending on the embodiment of the vehicle 100, the specific details of the battery pack 202 and/or the plurality of battery cells could vary. For example, battery cells could vary in nominal energy capacity, usable energy capacity, discharge rate, cell chemistry and cell type.

The powerpack 200 includes a charger 206 connected to the battery pack 202, more specifically to a top of the battery housing 204. The charger 206 is electrically connected to the battery cells of the battery pack 202 for charging the battery cells. The vehicle 100 includes a socket (not shown) electrically connected to the charger 206 for electrically connecting to an external power source for providing electricity to the charger 206 for charging the battery cells.

The powerpack 200 also includes an inverter 208 connected to the battery pack 202, more specifically to a left side of the battery housing 204. The inverter 208 is electrically connected to the battery cells of the battery pack 202 to receive electric power from the battery cells. The inverter 208 is electrically connected to the motor 138 to supply power from the battery cells to the electric motor 138. The inverter 208 converts the direct current (DC) from the battery cells to three-phase alternating current (AC) to be used by the motor 138. By controlling the electric power supplied to the motor 138, the inverter 208 controls the torque applied by the electric motor 138 to the rear wheel 120.

The vehicle 100 includes a closed-loop cooling circuit for cooling electronic components of the vehicle 100, including the powerpack 200 and the motor 138. Heat transfer in the cooling circuit is provided by a liquid coolant, such as a glycol-water coolant, although it is contemplated that different liquid coolants could be utilized. It is noted that while liquid coolant is provided, some gases may also be present in the cooling circuit, due to phase transitions or air infiltrations. In some embodiments, it is contemplated that the vehicle 100 could have one cooling circuit for cooling the powerpack 200 and a separate cooling circuit for cooling the motor 160. It is also contemplated that some components of the vehicle 100 could be cooled through air cooling.

The cooling circuit includes a coolant reservoir 210, a coolant pump (not shown), and a pair of radiators 212 (one of which is shown in FIG. 3). The cooling circuit includes channels (not shown) defined in the battery pack 202, the charger 206, the inverter 208 and the motor 138 to cool these components. Hoses 214 (some of which are shown in FIG. 3) provide the fluid connection between some of the components of the cooling circuit.

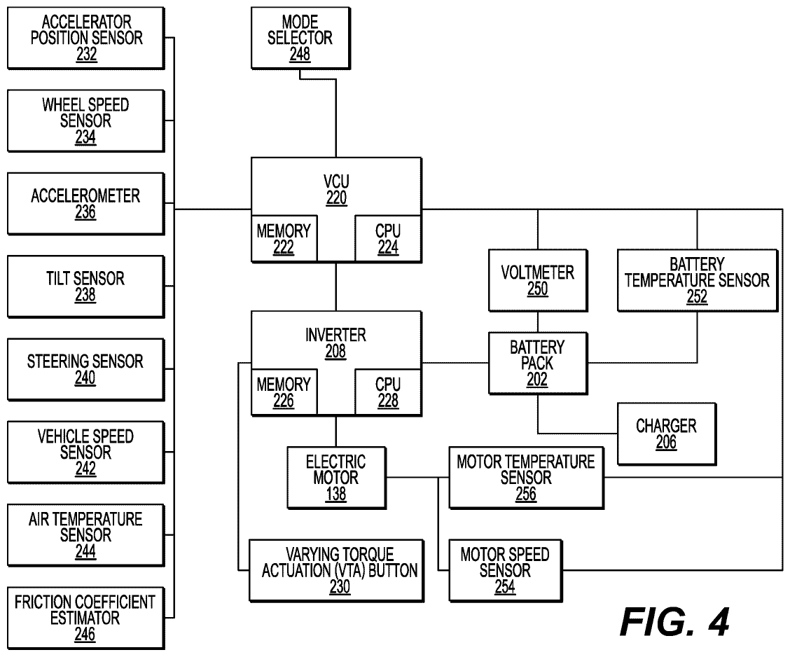

Turning now to FIG. 4, some additional electric and electronic components of the vehicle 100 will be described.

The vehicle 100 has a vehicle control unit (VCU) 220 used to control the electric motor 138 and various other components of the vehicle 100. The VCU 220 is connected to the frame 100 at a position spaced from the powerpack 200, but it is contemplated that the VCU 220 could be connected to the powerpack 200, such as on the battery pack 202. The VCU 220 has a memory 222 and a central processing unit (CPU) 224. It is contemplated that the VCU 220 could have more than one memory 222 and/or more than one CPU 224. The memory 222 stores computer executable instructions to be executed by the CPU 224 for controlling the various components of the vehicle 100 associated with the VCU 220.

The VCU 220 is electronically connected to the inverter 208, which together with the VCU 220, controls the electric motor 138. The inverter 208 has a memory 226 and a central processing unit (CPU) 228. It is contemplated that the inverter 208 could have more than one memory 226 and/or more than one CPU 228. It is also contemplated that the inverter 208 and the VCU 220 could share memory and/or CPU. The memory 226 stores computer executable instructions to be executed by the CPU 228 for controlling the electric motor 138.

The inverter 208 also receives signals from a varying torque actuation (VTA) button 230. The VTA button 230 selectively sends a varying torque input request to the inverter 208, the function of which will be described further below. The VTA button 230 is provided on the left side of the handlebar 160 as can be seen on FIG. 2. It is contemplated that the VTA button 230 could be replaced by a VTA switch or some other type of manual input device. It is also contemplated that the VTA button 230 could be placed elsewhere on the vehicle 100 within reach of a rider of the vehicle 100.

The VCU 220 is electronically connected to many sensors and devices to receive signals from these components and uses these signals to control the vehicle 100. It is contemplated that the vehicle 100 could have additional sensors and/or devices. It is also contemplated that one or more of the sensors and devices described below could be omitted. It is also contemplated that one or more of the sensors and devices described below could be replaced by other sensors and devices providing equivalent or similar functions.

An accelerator position sensor 232 senses a position of the accelerator 162. The VCU 220 uses the signal from the accelerator position sensor 232 to determine the desired torque to be applied by the electric motor 138. It is contemplated that the desired torque could also be determined in combination with signals received by the VCU 220 from other sensors and devices, some of which are described below.

A wheel speed sensor 234 senses a speed of rotation of the rear wheel 120 and sends a signal representative of this speed to the VCU 220. It is contemplated that the front wheel 118 could also be provided with a wheel speed sensor. A difference between the wheel speeds sensed by the rear wheel speed sensor 234 and the front wheel speed sensor could be used by the VCU 220 to determine if the rear wheel 120 is about to slip or is slipping.

An accelerometer 236 senses longitudinal forces applied to the vehicle 100 and sends a signal representative of these forces to the VCU 220. The VCU 220 uses this signal to determine the acceleration and deceleration of the vehicle 100. It is contemplated that accelerometers sensing lateral and vertical forces could also be provided. It is also contemplated that the accelerometer 236 could sense forces applied laterally and/or vertically in addition to longitudinally.

A tilt sensor 238 senses tilting of the vehicle 100 about a longitudinal axis and sends a signal representative of the tilt angle to the VCU 200. It is contemplated that a pitch sensor sensing pitching of the vehicle 100 about a lateral axis could be provided. It is also contemplated that a yaw sensor sensing yawing of the vehicle 100 about a vertical axis could be provided.

A steering sensor 240 senses a degree of turning of the handlebar 160 and sends a signal representative of the steering angle of the front wheel 118 to the VCU 220.

A vehicle speed sensor 242 senses a speed of the vehicle 100 and sends a signal representative of this speed to the VCU 220. The vehicle speed sensor 242 could be, for example, an optical speed sensor, a laser speed sensor, a pitot tube. It is contemplated that in some embodiments the vehicle speed sensor 242 could be omitted and that vehicle speed could be determined from the wheel speed sensed by the wheel speed sensor 234. It is contemplated that the vehicle speed could alternatively be determined from positional data obtained from a global positioning system (GPS). A difference between the vehicle speed sensed by the vehicle speed sensor 242 and the vehicle speed determined from the wheel speed sensor 234 could be used by the VCU 220 to determine if the rear wheel 120 is about to slip or is slipping. The VCU 200 can also cause the vehicle speed to be displayed on the display 164.

An air temperature sensor 244 senses a temperature of the air around the vehicle 100 and sends a signal representative of this temperature to the VCU 220. For example, if the air temperature is below the freezing temperature of water, the VCU 220 can adjust the control of the vehicle 100 to account for the possibility of slippery road condition due to the possible presence of ice on the ground. The VCU 220 can also cause the air temperature to be displayed on the display 164.

A friction coefficient estimator 246 estimates the friction coefficient of the surface on which the vehicle 100 operates and sends a signal representative of this friction coefficient to the VCU 220. The estimator 246 can use the signals from one or more of the other sensors and devices described herein to make this estimation. It is contemplated that the function of the estimator 246 could be integrated directly into the VCU 220. The VCU 220 can adjust the control of the vehicle 100 based on the estimated friction coefficient. For example, the VCU 220 could limit the acceleration of the vehicle 100 on surfaces having a lower estimated friction coefficient.

A mode selector 248 allows a rider of the vehicle 100 to select between a standard mode and a torque varying mode and sends a signal representative of this mode to the VCU 220. The VCU 220, together with the inverter 208, then controls the torque applied by the motor 138 based on the selected mode as will be described in more detail below. In the standard mode, the VCU 220 and the inverter 208 cause the desired torque to be applied by the electric motor 138. For all other operating conditions remaining the same, the desired torque is constant. In the torque varying mode, assuming some conditions are met as described below, for all other operating conditions remaining the same, the VCU 220 and the inverter 208 cause a varying torque to be applied by the electric motor 138. The varying torque mode will be described in more detail below. The mode selector 248 can be a button, a switch, a dial, or can be provided on the display 164 in embodiments where the display 164 is part of an infotainment system.

A voltmeter 250 and a battery temperature sensor 252 sense a voltage and a temperature of the battery pack 202 respectively and send corresponding signals to the VCU 220. It is contemplated that the battery temperature sensor 252 could sense the temperature of the battery pack 202 directly or could sense a temperature of the coolant exiting the battery pack 202.

A motor speed sensor 254 senses speed of rotation of an output shaft of the motor 138 and sends a corresponding signal to the VCU 220.

A motor temperature sensor 256 senses a temperature of the motor 138 and sends a corresponding signal to the VCU 220. It is contemplated that the motor temperature sensor 256 could sense the temperature of the motor 138 directly or could sense a temperature of the coolant exiting the motor 138.

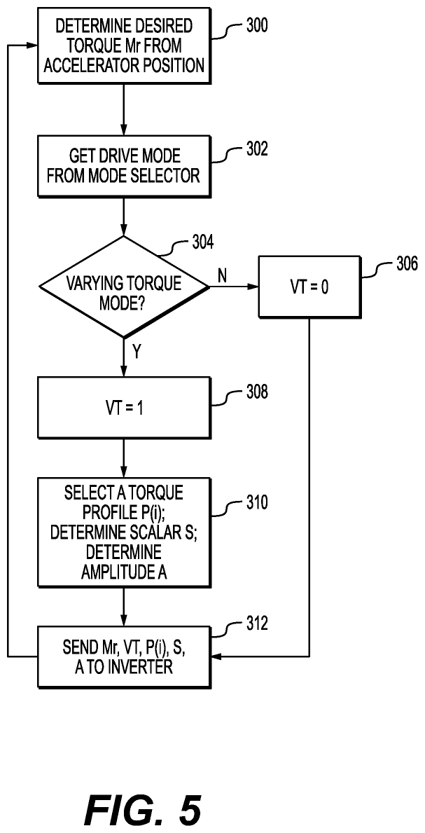

Turning now to FIGS. 5 to 7, a method for controlling a torque output of the electric motor 138 will be described. The present method, under certain conditions described below, causes the electric motor 138 to apply a varying torque. As a result, the electric motor 138 applies a varying torque with torque peaks that cause the rear wheel 120 to have peaks in traction that are then released before significant slip of the rear wheel 120 occurs, thus providing improved performance and driver feedback, similar to what occurs with some internal combustion engines. The varying torque applied by the electric motor 138 can be synchronous with the speed of rotation of the electric motor 138 by applying torque peaks at given angular intervals, which is similar to the effect occurring in some internal combustion engines. However, since the torque peaks are not linked to combustion events as is the case for an internal combustion engine, it is contemplated that the varying torque applied by the electric motor 138 can be asynchronous with the speed of rotation of the electric motor 138. For example, an asynchronous varying torque could apply torque peaks at given time intervals, regardless of the speed of rotation of the electric motor 128.

With reference to FIG. 5, with the vehicle 100 in operation, the method begins at 300 where the VCU 220 determines the desired torque Mr from the accelerator position. The accelerator position is obtained from a signal from the accelerator position sensor 232. As explained above, a number of factors in addition to the accelerator position can be used to determine the desired torque Mr.

Then at 302, the VCU 220 gets the drive mode from the mode selector 248. At 304, the VCU 220 selects the drive mode corresponding to the drive mode obtained at 302. In response to the standard mode being selected, then at 306 the VCU 220 sets the variable VT to a value of 0, and the method continues at 312 which will be described below. In response to the varying mode being selected, then at 308 the VCU 220 sets the variable VT to a value of 1, and the method continues at 310. In an alternative embodiment, step 302 is omitted. In such an embodiment, from step 304, the VCU 220 sets the variable VT to the value of 0 (step 306) if the VTA button 230 is not pressed and sets the variable VT to the value of 1 (step 308) if the VTA button 230 is pressed.

At 310, the VCU 220 selects a torque profile P(i), determines a scalar S, and determines an amplitude A.

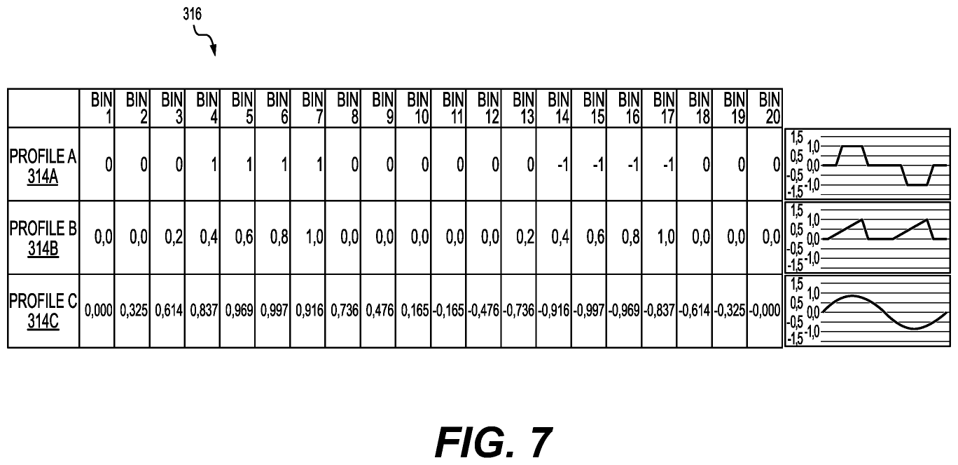

The torque profile P(i) is selected from a plurality of torque profiles stored in the memory 222. FIG. 7 illustrates three examples of torque profiles 314A, 314B, 314C. The torque profiles 314A, 314B, 314C are stored in the memory 222 in the form of a lookup table 316. In the lookup table 316, the torque profiles 314A, 314B, 314C are broken into bins corresponding to regular intervals along the curves of the torque profiles 314A, 314B, 314C, and each bin is assigned a numerical value varying between 1 and −1 corresponding to the position on the curves of the torque profiles 314A, 314B, 314C. As will be understood from the explanations provided further below, for bins having a value of 0, the electric motor 138 applies the desired torque Mr; for bins having a positive value, the electric motor 138 applies a torque that is greater than the desired torque Mr; and for bins having a negative value, the electric motor 138 applies a torque that is less than the desired torque Mr. As such, over a given profile, the electric motor 138 applies a varying torque. It is contemplated that there could be more or less than three torque profiles P(i) to select from. It is also contemplated that there could be only one torque profile P(i). The VCU 220 selects the torque profile P(i) based on the signals received from the various sensors and devices described above with respect to FIG. 4. For example, the torque profiles could correspond to different vehicle speed ranges or to different estimated friction coefficient of the surface on which the vehicle 100 operates. The rider could also select the type of riding condition, such as off-road dirt, off-road sand, off-road ice, off-road snow, and on-road, using a corresponding selector and the VCU 220 could then select the torque profile P(i) corresponding to the selected type of riding.

The scalar S determines how many bins of the selected torque profile P(i) will be used. As such, only part of the torque profile P(i) can be used and repeated, instead of using the entire torque profile P(i) and then repeating it. For example, for the torque profile 314A, having a scalar S of 20 will result in a varying torque having peaks higher than the desired torque Mr and throughs lower than the desired torque Mr, but having a scalar S of 10 will result in a varying torque having peaks higher than the desired torque Mr and throughs corresponding to the desired torque Mr. As such, by having the possibility of changing the scalar S, the VCU 220 can effectively create more torque profiles than are stored in the memory 222. The scalar S is determined based on the signals received from the various sensors and devices described above with respect to FIG. 4. It is contemplated that the scalar S could be a constant fixed value.

The amplitude A determines how much of a variation from the desired torque Mr the selected torque profile P(i) will generate. In some embodiments, the amplitude A is based on the desired torque Mr. For example, the value of the amplitude A could increase as the desired torque Mr increases. In other embodiments, the amplitude A, and therefore the degree of torque variation, could be set by the rider of the vehicle 100 using a corresponding selector. It is contemplated that the amplitude A could be a constant fixed value.

Then at 312, the VCU 220 sends the desired torque Mr, the selected drive mode (i.e., the value of VT), the selected torque profile P(i), the determined scalar S, and the determined amplitude A to the inverter 208. If the method arrives at 312 from 306 (i.e., VT=0), then there are no selected torque profile P(i), determined scalar S, and determined amplitude A sent to the inverter 208 as these have not been selected or determined. From 312, the VCU 220 returns to 306.

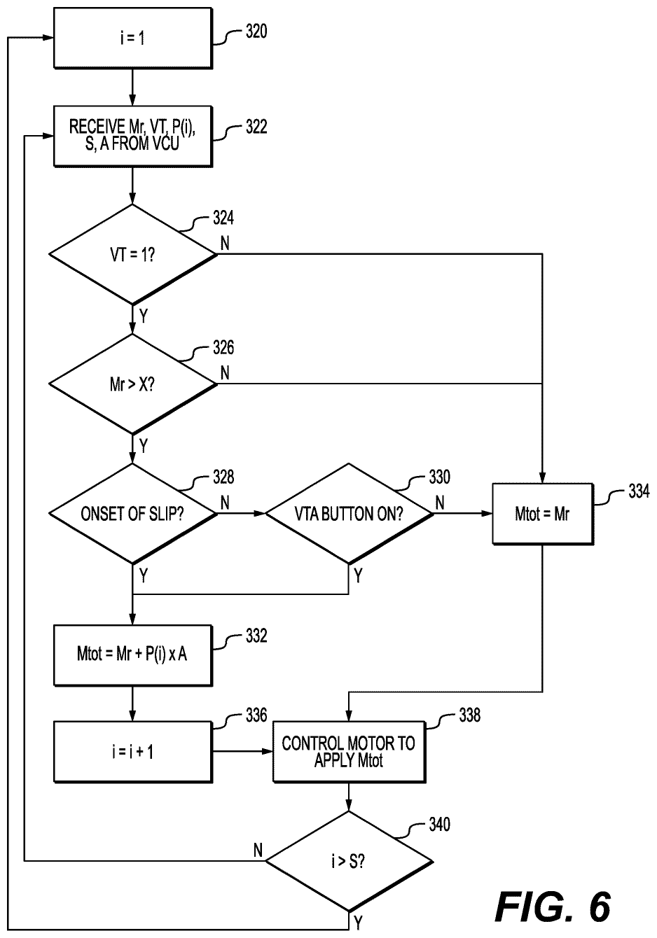

Turning now to FIG. 6, at 320 the inverter 208 starts by setting a counter value i to 1. Then at 322, the inverter 208 receives the desired torque Mr, the selected drive mode (i.e., the value of VT), and if applicable the selected torque profile P(i), the determined scalar S, and the determined amplitude A sent by the VCU 220 at 312.

Then at 324, the inverter 208 checks which of the drive mode has been selected. If the standard mode has been selected (i.e., VT=0), then the inverter 208 proceeds to 334 which will be described in more detail below. If the torque varying mode has been selected (i.e., VT=1), then the inverter 208 proceeds to 326.

At 326, the inverter 208 determines if the desired torque Mr is greater than a predetermined torque X. If the desired torque Mr is not greater than the predetermined torque X, then the inverter proceeds to 334. If the desired torque Mr is greater than the predetermined torque X, then the inverter proceeds to 328. As a result of step 326, the electric motor 138 will only apply a varying torque if the desired torque is above the predetermined torque X, thus preventing a varying torque to be applied a low values of the desired torque Mr.

At 328, the inverter 208 determines if the rear wheel 120 is at the onset of slip. This determination is achieved using some of the sensors and devices described above with respect to FIG. 4. Some ways of determining the onset of slipping have been briefly described above. Various methods of determining the onset of slip of the rear wheel 120 are possible and are known to those skilled in the art. As such, these will not be described in detail herein. If the rear wheel 120 is not at the onset of slip, the inverter 208 proceeds to 330. If the rear wheel 120 is at the onset of slip, the inverter 208 proceeds to 332. As a result of step 328, the electric motor 138 will apply a varying torque if the rear wheel 120 is at the onset of slip, thus helping to prevent such slip as a result of the varying torque.

At 330, the inverter 208 determines if a varying torque input request has been received from a manual input device. In the present embodiment, this corresponds to the VTA button 230 having been pressed. If the VTA button 230 is not pressed, the inverter 208 proceeds to 334. If the VTA button 230 is pressed, the inverter 208 proceeds to 332. Step 330 allows the rider of the vehicle 100 to cause the electric motor 138 to apply a varying torque on request. For example, as the vehicle 100 enters a curve at high speed, the rider can press the VTA button 230 to cause the electric motor 138 to apply a varying torque.

At 332, the inverter 208 sets the torque to be applied by the electric motor 138 Mtot to correspond to the varying torque. The varying torque is the sum of the desired torque Mr and a torque variation. In the present embodiment, the torque variation corresponds to the value of the selected torque profile P(i) in the bin corresponding to the value of the counter i multiplied by the amplitude A. For example, with reference to FIG. 7, if the torque profile 314B is selected, and the counter i has a value of 5, then the torque variation corresponds to 0.6 multiplied by the amplitude A. From 332, the inverter 208 proceeds to 336 where the counter i is increased by 1. From 336, the inverter 208 proceeds to 338 which is described below.

At 334, the inverter 208 sets the torque to be applied by the electric motor 138 Mtot to correspond to the desired torque Mr. This occurs in response to the standard mode (i.e., VT=0) being selected (step 324) or in response to conditions for applying a varying torque not being met (steps 326, 328, 330). From 334, the inverter 208 proceeds to 338.

At 338, the inverter 208 controls the electric motor 138 to apply the torque Mtot. The torque Mtot can be the desired torque Mr from step 334 or the varying torque from step 332 depending on which conditions were met in the preceding steps. From 338, the inverter proceeds to 340.

At 340, the inverter 208 determines if the value of the counter i is greater than the value of the scalar S. If not, the inverter 208 returns to step 322. If the value of the counter i is greater than the scalar S, then the inverter 208 returns to step 320 where the value of the counter i is reset to 1.

It is contemplated that the order of some of the above steps could be changed. For example, steps 328 and 330 could be interchanged. It is also contemplated that some of the steps could be omitted. For example, at least one of steps 326, 328 and 330 could be omitted. For example, in embodiments where step 328 is omitted, the method would proceed from step 326 to step 330. It is also contemplated that instead of step 326, the value of amplitude A could be set to zero when the desired torque Mr is less than the predetermined torque X. It is also contemplated that in some embodiments, a varying torque could always be applied by the electric motor 128.

It is contemplated that additional conditions could have to be met for the electric motor 138 to apply a varying torque (i.e., for Mtot to correspond to Mtot determined at 332). For example, the electric motor 138 could apply a varying torque only if the vehicle 100 is experiencing a certain degree of acceleration as determined from the accelerometer 236, the wheel speed sensor 234 or the motor speed sensor 254. In another example, the electric motor 138 could apply a varying torque only if the temperatures of the battery pack 202 and of the electric motor 138 are within appropriate temperature ranges since applying a varying torque generates more heat than applying the desired torque. In another example, the electric motor 138 could apply a varying torque only if the voltage of the battery pack 202 is within an appropriate range. In another example, the electric motor 138 could apply a varying torque only the battery pack 202 is capable of accepting a charge as under some circumstances applying a varying torque could engage the electricity regeneration functions of the vehicle 100. In another example, the electric motor 138 could apply a varying torque only if the calculated varying torque would not cause a negative torque to be applied (i.e., turning the output shaft of the electric motor 138 in a direction that would turn the rear wheel 120 in a direction to make the vehicle 100 move in reverse).

Modifications and improvements to the above-described embodiments of the present technology may become apparent to those skilled in the art. The foregoing description is intended to be exemplary rather than limiting. The scope of the present technology is therefore intended to be limited solely by the scope of the appended claims.

1. A method for controlling torque output of an electric motor of an electric vehicle, the electric vehicle having at least one ground engaging member, the method comprising:
receiving an accelerator position;
determining a desired torque from the accelerator position;
determining a torque variation, determining the torque variation comprising multiplying a torque profile by an amplitude value;
adding the torque variation to the desired torque;
determining a varying torque based at least in part on the desired torque; and
controlling the electric motor to apply the varying torque.

2. The method of claim 1, further comprising:
selecting one of a standard mode and a torque varying mode;
in response to the standard mode being selected:
controlling the electric motor to apply the desired torque; and
in response to the torque varying mode being selected:
the varying torque is determined; and
the electric motor is controlled to apply the varying torque.

3. The method of claim 1, further comprising receiving a varying torque input request from a manual input device; and
wherein the electric motor is controlled to apply the varying torque in response to the varying torque input request being received.

4. The method of claim 1, further comprising determining an onset of slip of at least one of the ground engaging members driven by the electric motor; and
wherein the electric motor is controlled to apply the varying torque in response to the onset of slip being determined.

5. The method of claim 1, wherein the varying torque is determined and the electric motor is controlled to apply the varying torque only in response to the desired torque being greater than a predetermined torque.

6. (canceled)

7. (canceled)

8. The method of claim 1, wherein the amplitude value is based at least in part on the desired torque.

9. The method of claim 1, wherein the torque profile is selected from a plurality of torque profiles.

10. The method of claim 1, wherein the varying torque is synchronous with a speed of rotation of the electric motor.

11. The method of claim 1, wherein the varying torque is asynchronous with a speed of rotation of the electric motor.

12.-20. (canceled)

21. An electric vehicle comprising:
a battery pack;
an inverter electrically connected to the battery pack;
an electric motor electrically connected to the inverter;
a vehicle control unit electronically communicating with the inverter; and
at least one ground engaging member operatively connected to and driven by the electric motor,
the vehicle control unit and the inverter having memory storing computer executable instructions for executing the method of claim 1.

22. The electric vehicle of claim 21, wherein the at least one ground engaging member is at least one wheel.

23. The electric vehicle of claim 22, wherein:
the at least one wheel is a rear wheel; and
the electric vehicle is an electric motorcycle further comprising:
a handlebar;
a front wheel operatively connected to the handlebar; and
a straddle seat disposed rearward of the handlebar.

24. The electric vehicle of claim 21, wherein the method further comprises:
selecting one of a standard mode and a torque varying mode;
in response to the standard mode being selected:
controlling the electric motor to apply the desired torque; and
in response to the torque varying mode being selected:
the varying torque is determined; and
the electric motor is controlled to apply the varying torque.

25. The electric vehicle of claim 21, wherein the method further comprises receiving a varying torque input request from a manual input device; and
wherein the electric motor is controlled to apply the varying torque in response to the varying torque input request being received.

26. The electric vehicle of claim 21, wherein the method further comprises determining an onset of slip of at least one of the ground engaging members driven by the electric motor; and
wherein the electric motor is controlled to apply the varying torque in response to the onset of slip being determined.

27. The electric vehicle of claim 21, wherein the varying torque is determined and the electric motor is controlled to apply the varying torque only in response to the desired torque being greater than a predetermined torque.

28. The electric vehicle of claim 21, wherein the amplitude value is based at least in part on the desired torque.

29. The electric vehicle of claim 21, wherein the torque profile is selected from a plurality of torque profiles.

30. The electric vehicle of claim 21, wherein the varying torque is synchronous with a speed of rotation of the electric motor.

31. The electric vehicle of claim 21, wherein the varying torque is asynchronous with a speed of rotation of the electric motor.
